(19) United States
(12) Patent Application Publication
(10) Pub. No.: US 2010/0044427 A1
(43) Pub. Date: Feb. 25, 2010

(54) SYSTEMS AND METHODS OF INTERACTION IWTH INVISIBLE PRINTING

(75) Inventors: Larry Lynch, Los Gatos, CA (US); Steve Swihart, Walnut Creek, CA (US); Jim Cordova, Sunnyvale, CA (US)

Correspondence Address: MURABITO, HAO & BARNES, LLP, TWO NORTH MARKET STREET, THIRD FLOOR, SAN JOSE, CA, 95113, US

(73) Assignee: LEAPFROG ENTERPRISES, INC., Emeryville, CA (US)

(21) Appl. No.: 12/196,595

(22) Filed: Aug. 22, 2008

(51) Int. Cl. G06K 19/06; G06F 17/00; G06K 7/10

(52) U.S. Cl. 235/375; 235/494; 235/468

(57) ABSTRACT

Systems and methods of interaction with invisible printing. In one embodiment, a printed page includes a printable surface, an invisible machine readable code disposed on the printable surface; and a human viewable image disposed on the printable surface. The invisible machine readable code may not absorb or reflect visible light substantially differently from the printable surface, in one embodiment. The invisible machine readable code may be detectable when exposed to infrared and/or ultraviolet light.

### FIELD OF INVENTION

Embodiments of the present invention relate to the field of interactive devices and potable, e.g., pen based, computing. More specifically, embodiments of the present invention relate to systems and methods using invisible printing.

### BACKGROUND

In the last twenty years, the use of personal computing devices, such as desktop computer systems, laptop computer systems, handheld computers systems, and tablet computer systems, etc., has grown tremendously. These personal computing devices provide users with a broad range of learning opportunities, interactive applications, business utilities, communication abilities, and entertainment possibilities.

Current personal computing devices provide access to these interactive applications via a user interface. Typical computing devices have on-screen graphical interfaces that present information to a user using a display device, such as a monitor, display screen or audio output, and receive information from a user using an input device, such as a mouse, a keyboard, a joystick, or a stylus.

Even more so than computing systems, reading books is ubiquitous among literate societies, and, by definition, a requirement of literacy. While a variety of computer-based devices have attempted to help teach people to read in a myriad of ways, typical on-screen graphical user interfaces have difficulty mimicking the “look and feel,” portability durability and ease of use of conventional printed matter.

A number of commercial offerings utilize a pen-based computer capable of sensing its position on a printed page based on a visible position code also printed on the page Based on determining such a position, the pen-based computer may interact with a printed page and/or a user in a wide variety of ways. One example of such a position encoding system is commercially available from Anoto, a Swedish company. The conventional position code may not be easily discernible by the human visual system due to the small size of the individual dots, and may appear as grayscale or a “halftone” effect on the printed page. Unfortunately, such grayscale or “halftone” effects detract from the visual appearance of the printed material.

### SUMMARY OF THE INVENTION

Therefore, a need exists for systems and methods for rendering interactive printed material with an enhanced visual appearance. In addition, a need exists for systems and methods for rendering interactive printed material with printing outside of the visible spectrum. A need exists for an encoded position pattern that is printed with ink that is not visible to the human eye. A need also exists for systems and methods for associating pen computer actions with positions within printed material for portable computers that also satisfies the above need. Such systems and methods can be used to enhance learning and entertainment of the printed matter. A further need exists for systems and methods for interaction with invisible printing that are compatible and complementary with existing portable computers, computer peripherals, methods of web access and printing processes. Embodiments in accordance with the present invention provide for these needs.

Accordingly, systems and methods of interaction with invisible printing are disclosed. In one embodiment, a printed page includes a printable surface, an invisible machine readable code disposed on the printable surface; and a human viewable image disposed on the printable surface. The invisible machine readable code may not absorb or reflect visible light substantially differently from the printable surface, in one embodiment. The invisible machine readable code may be detectable when exposed to infrared and/or ultraviolet light.

In accordance with an alternative embodiment of the present invention, a system for interacting with invisible printing includes a printed page including a printable surface, an invisible machine readable code disposed on the printable surface and a human viewable image disposed on the printable surface. The system further includes a pen-based computer system for determining the invisible machine readable code proximate to the human viewable image and for determining a position responsive to the invidisble machine readable code and for performing an action responsive to the position.

In accordance with another embodiment of the present invention, a portable computer system includes a processor, a memory coupled to the processor and an optical detector coupled to the processor. The processor is operable to receive input from the optical detector to determine a position of the portable computer over printed material comprising a position code invisible in the visible spectrum. The portable computer also includes an audio transducer for producing audio output under control of the processor. The portable computer is capable of producing audio output corresponding to the position based on the contents of the memory of the portable computer.

The printed material may include a book with pages having images printed thereon and/or text material printed thereon. The images and text may be printed in combination with the invisible position code so that positions of the images and text can be determined. Audio content associated with the textual material may include speech corresponding to the words. Audio content of voice and/or sounds may be associated with the images. The images and text of the printed material may relate to a specific title and/or theme or story that is closely associated with the book, in one embodiment.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 illustrates an exemplary portable computer system and interactive device, in accordance with embodiments of the present invention.

FIG. 2 shows an exemplary image bearing surface provided with a pattern of location determining marks, in accordance with embodiments of the present invention.

FIG. 3 shows an enlarged portion of the position code of FIG. 2, in accordance with embodiments of the present invention.

FIG. 4 illustrates an exemplary page comprising black text printed with a conventional position code, in accordance with the conventional art.

FIG. 5 illustrates an exemplary page comprising black text printed with an invisible position code, in accordance with embodiments of the present invention.

### DETAILED DESCRIPTION

Reference will now be made in detail to various embodiments of the present invention, examples of which are illustrated in the accompanying drawings while the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

Some portions of the detailed descriptions that follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

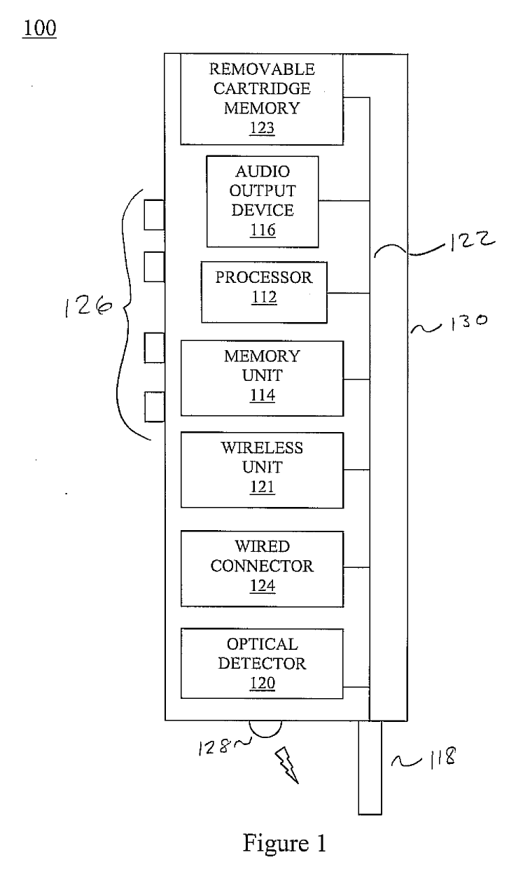

It should be borne in mind, however, that all of these and similar terms are to be associated with the appropriate physical quantities and are merely convenient labels applied to these quantities. It is appreciated that throughout the present invention, discussions utilizing terms such as “loading” or “recognizing” or “accessing” or “producing” or “decoding” or “recording” or “interfacing” or the like, often refer to the action and processes of an electronic system (e.g., interactive device 100 of FIG. 1), or similar electronic computing device, that manipulates and transforms data represented as physical (electronic) quantities within the electronic device's registers and memories into other data similarly represented as physical quantities within the electronic device memories or registers or other such information storage, transmission or display devices.

FIG. 1 illustrates an exemplary portable computer system and interactive device 100 for use with embodiments of the present invention, in accordance with embodiments of the present invention. Interactive device 100 includes processor 112, internal memory unit 114, audio output device 116, optional surface contacting element 118, optional removable cartridge memory 123, optional wireless unit 121, optional wired connector 124 and optical detector 120 within housing 130. In one embodiment, processor 112, memory unit 114, audio output device 116, optional surface contacting element 118, optional removable cartridge memory 123, optional wireless unit 121, optional wired connector 124 and optical detector 120 are communicatively coupled over bus 122. In one embodiment, interactive device 100 may also include an optical emitter 128, e.g., a light emitting diode (LED). In one embodiment, housing 130 may also contain a power supply operable to power circuits and functions of interactive device 100. In one embodiment, housing 130 may also include a display and/or input buttons 126 communicatively coupled with bus 122.

In one embodiment, housing 130 is shaped in the form of a stylus or a writing instrument (e.g., pen-like). In this embodiment, device 100 comprises a pen-based computer system. A user may hold interactive device 100 in a manner similar as a pen or stylus is held. Surface contacting element 118 is located at one end of housing 130 such that a user can place surface contacting element 118 in contact with a surface (not shown). Surface contacting element 118 may include a pen, a pencil, a marker, a crayon, chalk, or any other marking material. It should be appreciated that surface contacting element 118 may also include a non-marking element such as a stylus type tip. It should also be appreciated that surface contacting element 118 may also have magnetic properties. During use, a user can hold interactive device 100 and use it in a similar manner as a writing instrument to mark a surface, or to touch a surface without marking the surface, utilizing surface contacting element 118. Surface contacting element 118 may detect contact with a surface, e.g., via pressure or displacement, and signal such contact to processor 112.

Interactive device 100 allows users to indicate, e.g., touch or hover over, selectable items that represent or symbolize different functions provided by interactive device 100. For example, a user may touch an image printed on a surface, e.g., a surface comprising a substantially invisible position code. In another embodiment, it may not be necessary to make physical contact with the surface to determine and indicate a position. In one embodiment, the selectable item includes a symbolic representation of an application program or function executable by processor 112. Computer code for recognizing such functional selectable items and distinguishing them from other images can reside in memory unit 114 and/or removable cartridge memory 123 in interactive device 100.

Optical detector 120 is at one end of the stylus-shaped interactive device 100. Optical detector 120 is operable to detect information on a surface. In one embodiment, interactive device 100 also comprises an optical emitter for illuminating a portion of a surface that is detected by optical detector 120. The information detected by optical detector 120 is transmitted to processor 112.

Processor 112 may include any suitable electronics to implement the functions of the interactive device 100. Processor 112 can recognize selectable items, and can identify the locations of those selectable items so that interactive device 100 can perform various operations. In these embodiments, memory unit 114 and/or removable cartridge memory 123 may comprise computer code for correlating selectable items with their locations on the surface.

Memory unit 114 and/or removable cartridge memory 123 comprises computer code for performing any of the functions of the interactive device 100. In one embodiment, computer code stored in memory unit 114 and/or removable cartridge memory 123 and implemented on processor 112 is responsive to a selectable item and operable to execute a function associated with the selectable item in response to the selection.

In accordance with embodiments of the present invention, the interactive device 100 may optionally comprise wireless communications unit 121. Optional wireless communications unit 121 may implement any suitable wireless communications protocol, including, for example, Bluetooth communications, wireless Ethernet, e.g., IEEE 802.11b and/or 802.11g, Infrared Data Association (IrDA) communications and the like. Optional wireless communications unit 121 enables interactive device 100 to communicate wirelessly with another device, for example, a desktop or laptop computer, a hand held computer, a mobile phone and/or a wireless access point, e.g., a “hot spot.” Interactive device 100 may wirelessly access content on such another device, e.g., a nearby computer, or utilize such a device to access yet another device, e.g., via a network, for example, the internet.

Similarly, optional wired connector 124 may enable interactive device 100 to communicate wirelessly with another device, for example, a desktop or laptop computer, a hand held computer, a mobile phone or the like, in accordance with embodiments of the present invention. Wired connector 124 may be compatible with any suitable wired communication protocol, including, for example, RS-232, universal serial bus (USB), Inter-Integrated Circuit (I2C) communications, serial peripheral interface (SPI) communications, optical communications and the like. Interactive device 100 may utilize wired connector 124 to access content on another device, e.g., a nearby computer, or utilize such a device to access yet another device, e.g., via a network, for example, the internet.

Optional removable cartridge memory 123 may enable interactive device 100 to receive computer readable information that has been stored onto removable cartridge memory 123 by another device. Optional removable cartridge memory 123 may comprise any suitable data storage medium, for example, data storage devices compatible with a Secure Data (SD) card, multi-media card (MMC), compact flash (SF) card, PC Card, diskette and the like.

Optional buttons 126 may include, for example, buttons to control operation of interactive device 100, in particular the rendering of audio material that is associated with printed media. Exemplary button functions include power, play, stop, repeat, pause, volume control, next (go to the next book stored in the interactive device 100) and the like.

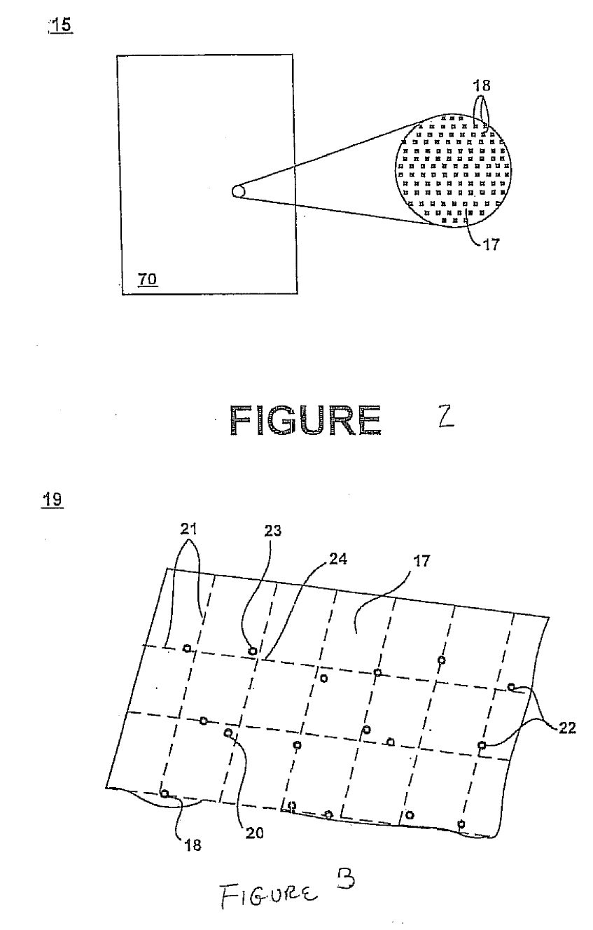

FIG. 2 shows an exemplary image bearing surface 15 provided with a pattern of location determining marks, in accordance with embodiments of the present invention. In the embodiment of FIG. 2, image bearing surface 15 is provided with a coding pattern in the form of optically readable position code 17 that consists of a pattern of marks 18. The marks 18 in FIG. 2 are greatly enlarged for the sake of clarity. In one embodiment, the marks 18 are embodied as dots; however, the present invention is not so limited. In one embodiment, the dots are permanently printed on the image bearing surface.

FIG. 3 shows an enlarged portion 19 of the position code 17 of FIG. 2, in accordance with embodiments of the present invention. An interactive device such as interactive device 100 (FIG. 1) is positioned to capture an image of a region of the position code 17. In one embodiment, the optical device fits the marks 18 to a reference system in the form of a raster with raster lines 21 that intersect at raster points 22. Each of the marks 18 is associated with a raster point 22. For example, mark 23 is associated with raster point 24. For the marks in an image/raster, the displacement of a mark from the raster point associated with the mark is determined. Using these displacements, the pattern in the image/raster is compared to patterns in the reference system. Each pattern in the reference system is associated with a particular location on the image bearing surface 70. Thus, by matching the pattern in the image/raster with a pattern in the reference system, the position of the pattern on the surface 70, and hence the position of the optical device relative to the surface 70, can be determined.

Anoto, a Swedish company, employs a technology that uses an algorithm to generate a pattern that enables a very large unique data space for non-conflicting use across a large set of documents. Their pattern, if fully printed, would cover 70 trillion 8.5″×11″ pages with unique recognition of any 2 cm square on any page. Paper containing the specific dot patterns is commercially available from Anoto. The following patents and patent applications are assigned to Anoto and describe this basic technology and are all herein incorporated by reference in their entirety for all purposes: U.S. Pat. No. 6,502,756, U.S. application Ser. No. 10/179,966, filed on Jun. 26, 2002, WO 01/95559, WO 01/71473, WO 01/75723, WO 01/26032, WO 01/75780, WO 01/01670, WO 01/75773, WO 01/71475, WO 00/73983, and WO 01/16691.

A particular instance of an image bearing surface, e.g., image bearing surface 70 of FIG. 2, may comprise an encoded pattern of location information as described previously. The specific location information encoded into the image bearing surface, or “dot-space” of the image bearing surface, may generally be known an interactive device, e.g., interactive device 100 (FIG. 1).

For example, an interactive device may associate a first location encoding, or “dot-space,” with a first application, e.g., a specific book title. Consequently, whenever that first location is detected, e.g., an interactive device scans a piece of paper with the first location encoding, the interactive device executes software associated with the specific book. In this case, the dot-space of the paper is known to the interactive device.

In accordance with embodiments of the present invention, an interactive device may have information of a plurality of dot spaces, e.g., the interactive device “knows” several different books. In accordance with other embodiments of the present invention, an interactive device may be associated with a particular application, e.g., a specific book title, and may not have information about other applications utilizing the same dot space. For example, an interactive device only “knows” a single book, whereas a different interactive device only “knows” a different single book. In this manner, a particular dot space may be reused for different applications

In accordance with alternative embodiments of the present invention, removable cartridge memory 123 (FIG. 1), wireless unit 121 and/or wired connector 124 may be utilized to communicate software, e.g., including audio information, and dot space information to interactive device 100. In this manner, interactive device 100 may associate a particular dot space with a particular printed media, and determine the proper interactions, including audio output, associated with particular locations within the printed media, e.g., a particular book.

While the position code 17 (FIG. 2) may be difficult to discern without magnification, it is appreciated that the marks 18 (FIG. 2) are conventionally printed in a dark, e.g., black, ink. Thus, the conventional marks are not actually invisible. Rather, due to their relatively small size and the presence of “white” space in-between the marks, the human visual system does not generally discern the individual marks, but rather “integrates” the image into a grayscale or a “halftone” effect. Unfortunately, such grayscale or “halftone” effects detract from the visual appearance of the printed material.

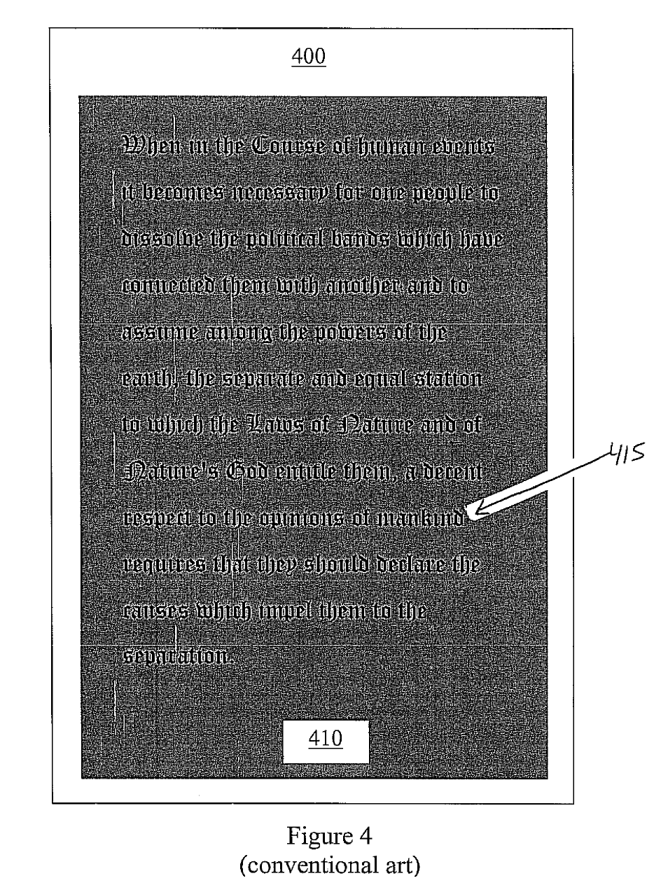

FIG. 4 illustrates an exemplary page 400, e.g., a page of a book, comprising black text 415 printed with a conventional position code 410, in accordance with the conventional art. Page 400 may be white or another “light” color, and its finish may be flat, matte or glossy. Position code 410 may be printed with the same ink as the text. Due to the relatively small size of the marks and intervening white space comprising position code 410, position code 410 is generally perceived as grey. It is appreciated that position code 410 generally detracts from the visual appearance of page 400, and may make it more difficult to read the text 415, for example due to decreased contrast, relative to black printing on a white background.

Written material, including printed material, generally comprises dark markings, e.g., text, upon a lighter surface. As light falls upon the material, less light is reflected from the dark markings than the light background, producing contrasting visual fields that are perceived by the human visual system. It is, of course, possible to provide light markings on a dark background, but such systems are less preferred.

Referring once again to FIG. 1, interactive device 100 may sense a position code in much the same manner as humans, but at higher resolution. For example, interactive device 100 may sense position coding marks due to decreased reflectivity of light, either ambient light or light provided by interactive device 100.

In accordance with embodiments of the present invention, a position code, or other marks for interacting with a scanning device, e.g., a pen-based computer, may be made that is completely invisible to the human visual system. In such a way, the position encoding marks are invisible to the human eye, thereby substantially eliminating the grey shadow or cast of the pages.

The human visual system is generally capable of responding to light with wavelengths from about 380 nm to 750 nm. The band of wavelengths visible to the human system is generally referred to or known as “visible light,” the “visible spectrum” and/or the “optical spectrum.” When referring to embodiments in accordance with the present invention, the term “invisible” refers to printed material, e.g., ink, that does not reflect light in the 380 nm to 750 nm range.

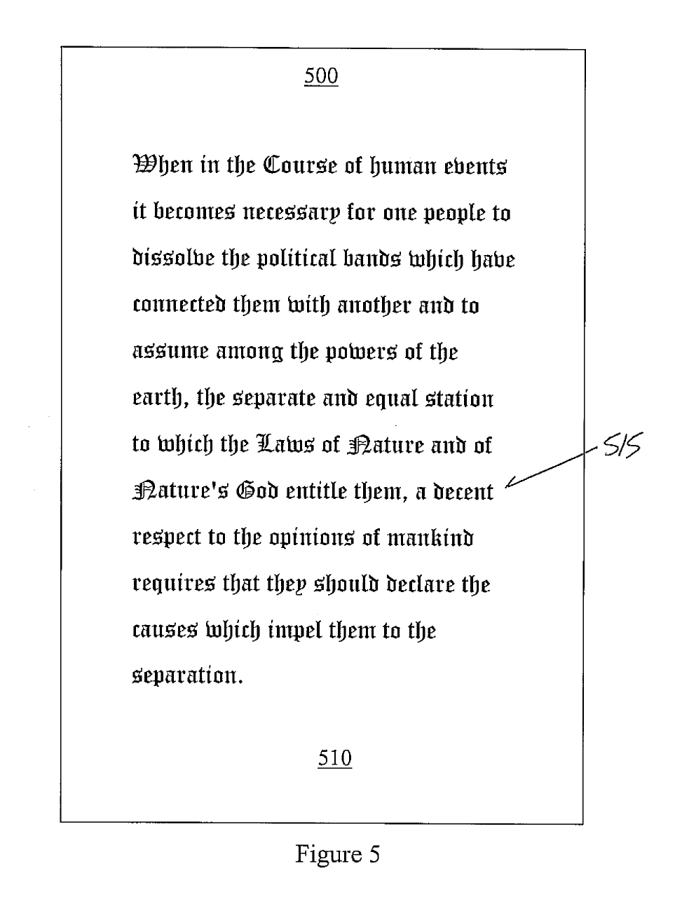

FIG. 5 illustrates an exemplary page 500, e.g., a page of a book, comprising black text 515 printed with an invisible position code 510, in accordance with embodiments of the present invention. Page 500 may be white or another “light” color, and may be flat, matte or glossy. Position code 510 is printed with an ink that is invisible to the human visual system. For example, the invisible ink neither absorbs nor reflects visible light, or does so with similarity to the page 500 material. In accordance with embodiments of the present invention, invisible position code 510 may be absorptive and/or reflective in either infrared and/or ultraviolet wavelengths.

In accordance with embodiments of the present invention, an interactive device, e.g., interactive device 100 (FIG. 1), may sense position coding marks, e.g., invisible position code 510, due to decreased reflectivity of light outside the visible spectrum, either ambient light or light provided by interactive device 100. In accordance with alternative embodiments of the present invention, an interactive device, e.g., interactive device 100, may sense position coding marks, e.g., invisible position code 510, due to increased reflectivity of light outside the visible spectrum.

For example, in an exemplary infrared absorptive embodiment in accordance with the present invention, an invisible position code is printed with an ink that does not reflect visible light and that absorbs infrared light. For example, the ink reflects less infrared light than the material of the printed page. An interactive device, e.g., interactive device 100 (FIG. 1), emits infrared light, and detects a position code due to infrared reflectivity differences between the coding marks and the background material. It is appreciated that the infrared emitter may also emit visible light, e.g., in combination with infrared light, in accordance with embodiments of the present invention. Such visible light may be useful, for example, to provide an indication to a user of a field of operation of the interactive device.

In accordance with embodiments of the present invention, reflective embodiments may be favored. For example, an invisible position code, e.g., invisible position code 510, may be more easily detected and/or decoded when printed with an ink that increases infrared reflectivity over the background material. Such an embodiment is analogous to “white on dark” printing in an infrared spectrum. Since the position code is invisible to the human visual system, longstanding human preferences for “dark on light” printing need not dictate the operation of an interactive device, e.g., interactive device 100 (FIG. 1).

Ultraviolet (UV) emitters, e.g., UV light emitting diodes (LEDs), as well as detectors sensitive to ultraviolet light, are known. However, such emitters and detectors are generally more expensive at present than corresponding infrared devices. Future cost improvements and/or other benefits of ultraviolet devices, for example, greater resolution corresponding to smaller wavelengths, may favor ultraviolet embodiments over infrared embodiments. All embodiments detecting light energy outside of a visible spectrum, including infrared and ultraviolet, are considered within the scope of the present invention.

In accordance with embodiments of the present invention, an interactive device, e.g., interactive device 100 (FIG. 1), may be responsive to both visible, e.g., “substantially” invisible codes, and invisible position codes. For example, an optical detector, e.g., optical detector 120 (FIG. 1), may be sensitive to visible and infrared light. Such an interactive device may, for example, be able to interact with material comprising conventional substantially invisible position codes as well as novel invisible position codes disclosed herein. Such a device may advantageously leverage existing materials comprising conventional substantially invisible position codes, e.g., is backwards compatible, while enabling improved visual appearances via utilization of novel invisible position codes.

Alternatively, in accordance with embodiments of the present invention, conventionally printed position codes, e.g., “substantially invisible” codes printed with human readable inks, may be detected in the infrared and/or ultraviolet spectrum. For example, in addition to being visible to humans, such printing may also be discernable in wavelengths outside of human visual acuity. Hence, an interactive device, e.g., interactive device 100 (FIG. 1), may be responsive to both visible, e.g., “substantially” invisible codes, and invisible position codes, via detection outside of the visible spectrum, e.g., via infrared and/or ultraviolet detection.

In accordance with embodiments of the present invention, an ink may be formulated that is invisible in the human visible spectrum that absorbs infrared light. Due to the small scale of the position code, for example, marks of greatest dimension of less than about 150 μm, e.g., about 95 to 100 μm, the ink should be compatible with an offset, “micro printing” process. In addition, a non-UV cure printing process may be beneficial, as such infrared absorbing inks may be destroyed by high intensity LTV energy, as utilized in conventional UV-curing. Ink that absorbs UV energy, e.g., a UV absorbent embodiment, should also benefit from a non-UV cure printing process, as ink intended to absorb UV energy is likely to be damaged by high intensity UV energy, as utilized in conventional IN-curing. An exemplary printing process utilizes air curing, in accordance with embodiments of the present invention.

In one exemplary embodiment in accordance with the present invention, position encoding “dots” may be printed using SDA 1910 dye, commercially available from H. W. Sands Corp. of Jupiter, Fla. This dye may be utilized at concentrations of from 0.5% to about 10% in a standard extender, e.g., Flint Ink Arrowstar 8030, commercially available from the Flint Group of Luxembourg. The final ink may benefit from milling the SDA 1910 dye, as opposed to conventional methods of dissolving the dye in the extender.

Embodiments in accordance with the present invention are well suited to a wide variety of marks, and are not limited to position coding marks, e.g., as available from Anoto. Embodiments in accordance with the present invention are well suited to detecting a variety of machine-readable marks printed in invisible ink, including, for example, one and two-dimensional bar codes, alpha-numeric characters whether designed for optical recognition or not, characters compatible with MICR Magnetic Ink Character Recognition) E-13B (routing codes on checks), e.g., without magnetic properties, and the Eke. Embodiments in accordance with the present invention are well suited to shape sorters, point and read systems and self-propelled devices, e.g., a “smart” toy, that follow an invisible line of invisible ink. For example, a child may mark a line using invisible ink that a toy subsequently traverses.

Embodiments in accordance with the present invention provide for systems and methods for rendering interactive printed material with an enhanced visual appearance. In addition, embodiments in accordance with the present invention provide for systems and methods for rendering interactive printed material with printing outside of the visible spectrum. Embodiments in accordance with the present invention also provide for systems and methods for associating pen computer actions with positions within printed material for portable computers Further, embodiments in accordance with the present invention provide for systems and methods for interaction with invisible printing that are compatible and complementary with existing portable computers, computer peripherals, methods of web access and printing processes.

Various embodiments of the invention are thus described. While the present invention has been described in particular embodiments, it should be appreciated that the invention should not be construed as limited by such embodiments, but rather construed according to the below claims.

What is claimed is:

1. A printed page operable to interact with an optical machine comprising:
a printable surface;
an invisible optical machine readable code disposed on said printable surface; and
a human viewable image disposed on said printable surface.

2. The printed page of claim 1 wherein said invisible optical machine readable code does not absorb or reflect visible light substantially differently from said printable surface.

3. The printed page of claim 1 wherein said invisible optical machine readable code is optically detectable when exposed to infrared light.

4. The printed page of claim 1 wherein said invisible optical machine readable code is optically detectable when exposed to ultraviolet light.

5. The printed page of claim 1 wherein said invisible optical machine readable code identifies positions on said printed page.

6. The printed page of claim 5 wherein said invisible optical machine readable code comprises individual marks of less than about 150 μm in greatest dimension separated by a background of said printable surface.

7. The printed page of claim 1 wherein said invisible optical machine readable code comprises optically readable marks of the set consisting of one dimensional bar codes; two dimensional bar codes; alphanumerical characters; and characters designed for optical recognition.

8. An interactive system comprising:
a printed page comprising:
a printable surface;
an invisible machine readable code disposed on said printable surface;
a human viewable image disposed on said printable surface;
a portable computer system for reading a portion of said invisible machine readable code that is proximate to said human viewable image; and
wherein said portable computer system is also for performing an action responsive to said determining.

9. The system of claim 8 wherein said invisible machine readable code identifies positions on said printed page.

10. The system of claim 8 wherein said invisible machine readable code is machine detectable when exposed to infrared or ultraviolet light.

11. The system of claim 8 wherein said human viewable image comprises a word text and wherein said action comprises human-audible output comprising a spoken sound of said word.

12. The system of claim 8 wherein said human viewable image comprises a substantially non textual image of an object, and wherein said action comprises human-audible output comprising a human language name of said object.

13. The system of claim 8 wherein said human viewable image comprises a substantially non textual image of an object, and wherein said action comprises human-audible output comprising non speech sounds.

14. The system of claim 13 wherein said non speech sounds comprise music.

15. The system of claim 13 wherein said non speech sounds comprise a sound effect associated with said non textual image.

16. A portable computer system comprising:
a processor
a memory coupled to said processor and for storing audio content that is associated with positions of printed material;
an optical detector coupled to said processor;
wherein said processor is for receiving input from said optical detector to determine a position of said portable computer system located over printed material comprising a position code invisible in the visible spectrum, responsive to an interaction of said portable computer system and said printed material; and
an audio transducer for producing audio output under control of said processor;
wherein said processor is also for generating audio output corresponding to said position contemporaneously with said interaction.

17. The portable computer system of claim 16 wherein said audio output comprises a spoken word corresponding to printed text at said position.

18. The portable computer system of claim 16 wherein said audio output comprises non word sounds corresponding to graphic images printed at said position.

19. The portable computer system of claim 16 wherein said processor is further for obtaining software describing a correspondence between positions of said printed material and said audio output.

20. The portable computer system of claim 16 wherein software describing a correspondence between positions within said printed material and said audio output is loaded into said portable computer via a removable memory.

21. The portable computer system of claim 16 further comprising a user operable button to command said processor to produce audio output corresponding to text of said printed material without reference to said printed material.

22. The portable computer system of claim 16 further comprising an optical detector responsive to light energy outside of the human visual spectrum for detecting position codes.
